(19) United States
(12) Patent Application Publication
(10) Pub. No.: US 2013/0042818 A1
(43) Pub. Date: Feb. 21, 2013

(54) HANDS-FREE PET LEASH WAIST-BELT

(71) Applicant: Barbara Capoano, Farmingdale, NJ (US)

(72) Inventor: Barbara Capoano, Farmingdale, NJ (US)

(21) Appl. No.: 13/418,513

(22) Filed: Mar. 13, 2012

Related U.S. Application Data
(60) Provisional application No. 61/524,180, filed on Aug. 16, 2011.

(51) Int. Cl. A01K 27/00

(52) U.S. Cl. 119/770

(57) ABSTRACT

A waist-belt including at least one embedded, retractably controllable pet leash for freeing a user's hand when walking or running with a dog, with means coupled with the belt to attach to, and allow, carrying of a grocery or shopping bag, a pocketbook, or water bottle at the same time, and with controllable front and rear manners of illumination to provide visualized warnings and detection of such activities safely during both daytime and nighttime hours.

### CROSS-REFERENCE TO RELATED APPLICATIONS

A Provisional Patent Application covering the invention described herein was filed on Aug. 16, 2011, and assigned Ser. No. 61/524,180.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not Applicable

### BACKGROUND OF THE INVENTION

2. Field of the Invention

This invention relates to a multi-purpose leash system for safely walking or running with a dog during daytime or nighttime hours—and more particularly, with a multiple of dogs at the same time.

2. Description of the Related Art

As will be appreciated, increasing numbers of mental health professionals are advancing the having and caring for a pet as a means of reducing one's daily stress level. Starting with a recognition that in a great many farm and rural locations, residents almost always have a family dog, the advantages that follow from having one as a companion has rapidly spread to suburban inhabitants, and from there to the urban population. One need only walk one morning through a suburban development, through the streets of a town or village, or through the caverns of a metropolitan area to see all the dog owners out there accompanied by their breeds, their half-breeds, and even their no-breed faithful friends. In fact, in the more populated areas, it is not uncommon to find dog-sitting establishments where a business person or office worker might bring their pet to in the morning on the way to work, to stay with others of their ilk, while their owner is away trying to earn a living. The more successful ones of these enterprises have been known to care for upwards of a dozen and more of these four-legged creatures walking, sitting and lying about a lobby or rest area, individually attended to by staff who treat them only as a grandmother can.

As will also be appreciated along these lines, one of the thriving businesses found in a city environment of such dog inhabitants is that of professional dog walker. For a fee, oftentimes out-of-work people, those who are retired, students or just those whose work schedule permits, would walk one dog on a scheduled basis, to provide them with companionship during the day, to exercise them, or just to be with them when it is “time-to-go” or “do their business”. Seeing one, two, three, four and sometimes as many as six dogs, each on a separate leash, being walked together at the same time by only a single individual, is not that an uncommon sight to see in the streets or avenues of a large city.

As will further be appreciated, it would there be advantageous to have available a leash system which could be employed on a hands-free basis, allowing the one walking the dogs to be freed of the requirement of holding onto each leash to begin with. Incorporating such concept in a “waist-belt” will be recognized as being beneficial to allow the walker of the dogs to, at the same time, carry a grocery bag, a shopping bag, a pocketbook or most any other item that could be carried—and generally, in other words, to do or hold other things with their hands without having to hold onto each leash. Realizing that this teaching could apply equally as well to the simultaneous walking of just two dogs—and even to just one dog—the following objects of the invention will be apparent.

### OBJECTS OF THE PRESENT INVENTION

It is an object of the present invention, therefore, to provide a hands-free “waist-belt” which will allow the walking or running with a dog, in a simple, easy-to-use manner.

It is an object of the invention, also, to provide such a hands-free “waist-belt” designed to allow other items to be carried about by the user at the same time, either in the user's hands or by connection to the belt.

It is another object of the invention, to provide a hand's-free “waist-belt” system that recognizes that some dogs, when being walked or allowed to run, are more “adventurous” or “inquisitive” than others, and addressing that through the use of individually controllable leashes in permitting differing freedoms of movement to each dog.

It is a further object of the invention to provide this type of hands-free “waist-belt” system in a manner which enables the walking or running of the dog or dogs on their leash in a way that is both safe for them and for their handler during both daytime and nighttime hours in a vision-protecting set-up manner.

### SUMMARY OF THE INVENTION

As will become clear from the following description, these objectives are achieved by employing a “waist-belt” with retractable leashes presented on opposing sides of its coupling buckle when worn. With the belt being of adjustable waist dimension, actuation buttons are provided for the freeing and/or controlling of the leash length drawn out. A plurality of hooks are spaced along the belt, for example, for the hanging of bags, of pocketbooks or of other items that might normally be carried in one's hands or arms, in allowing them to hang from the belt instead.

In accordance with the “safety” aspect of the invention, the hands-free “waist-belt” is additionally provided with visibly observable stripes or light reflecting indicants along its length of a type as typically would glow in the dark, or shine upon being illuminated by incident vehicle lights, street lights or store lights. Furthermore, in a preferred embodiment, ON-OFF bulbs or light emitting diodes (LED's) are incorporated to be actuated in themselves casting illumination when walking or running in darkened or dim lit areas as a means of warning and/or identification. Pockets for the carrying of keys, snacks, cellphones, etc. in the “waist-belt” are also within the scope of the invention—all of which go towards giving the user a hands-free leash control and movement. These features characterize the companionship and exercise aspects of the invention in a manner which continues to foster the decrease in stress level which is so highly desired and promoted by today's mental health therapists.

### BRIEF DESCRIPTION OF THE DRAWINGS

These and other features of the present invention will be more clearly understood from a consideration of the following description taken in connection with the accompanying Drawings in which:

FIGS. 1 and 2 are front and rear perspective views respectively of the hands-free pet leash waist-belt of the invention;

FIGS. 3 and 4 are illustrations helpful in an understanding of the adjustable control aspects available in its usage;

FIG. 5, 5A, 6 and 7 are illustrations helpful in an understanding of additional uses to which the waist-belt may be put while walking or running with a dog in accordance with the hands-free pet leash features of alternative embodiments of the invention;

FIG. 8 is a view helpful in understanding the retractability feature of the invention in controlling leash movement of the dog being walked or run with; and

FIGS. 9 and 10 are illustrations of how a pair of dogs may be walked or run with simultaneously—with FIG. 11 illustrating how the “waist-belt”, could be modified for wearing at one's arm, instead of about one's waist.

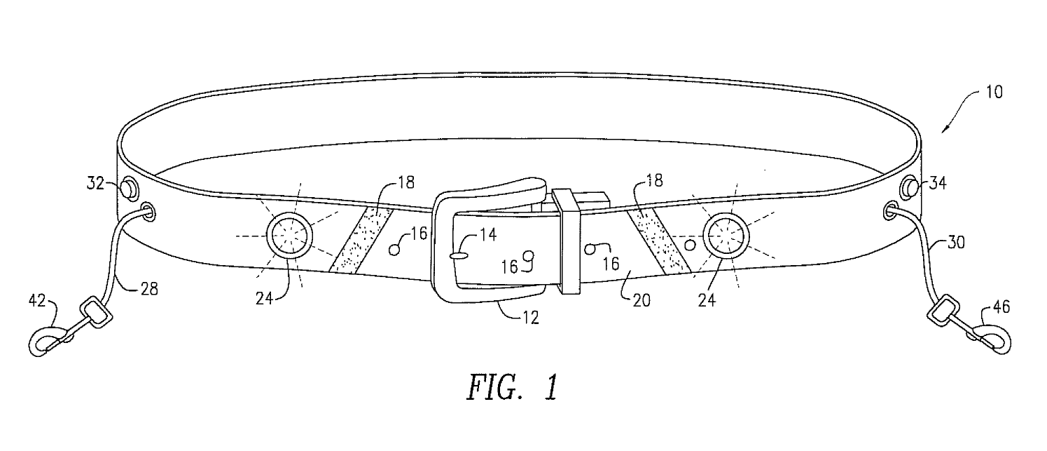

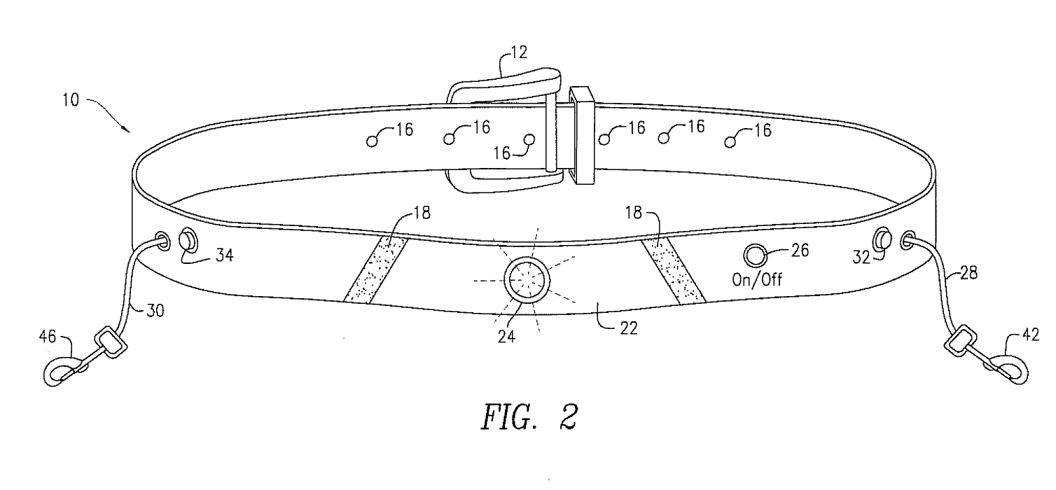

### DETAILED DESCRIPTION OF THE INVENTION

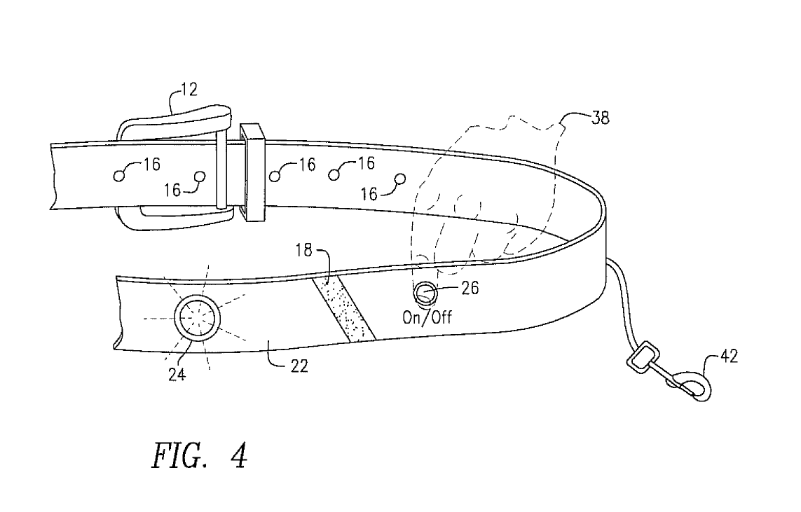

In the Drawings, the waist-belt 10 is shown as having a buckle 12, and with adjustments in its length dimension being afforded through its commonly employed probe 14 and a series of longitudinally spaced aperture openings 16. Pairs of conventional glow-in-the-dark stripes 18 are embedded in both the front 20 and back 22 of the belt 10 to provide a warning-illumination during nighttime hours of walking or running with the dog or dogs. Illuminable ON-OFF bulbs or light emitting diodes 24 are likewise embedded in the front 20 and back 22 for the same reasons, as well as for daytime use. A button control for actuating the bulbs or light emitting diodes is shown at 26, on the back 22 of the belt 10 (FIG. 4). Individual extendably retractable leashes 28, 30 are shown incorporated in the belt on either side of its buckle 12, individually controllable for release and extension by its button adjustments 32, 34.

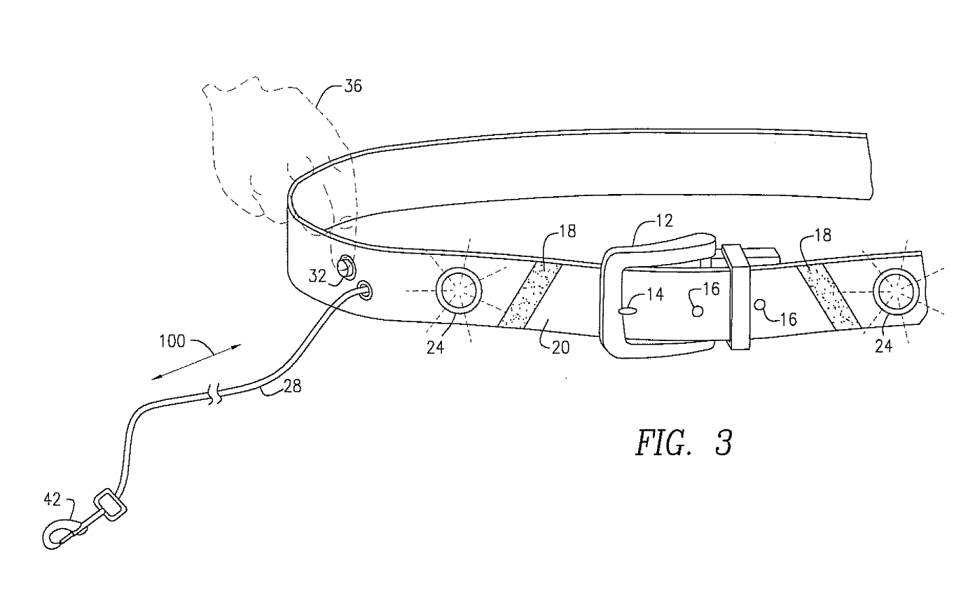

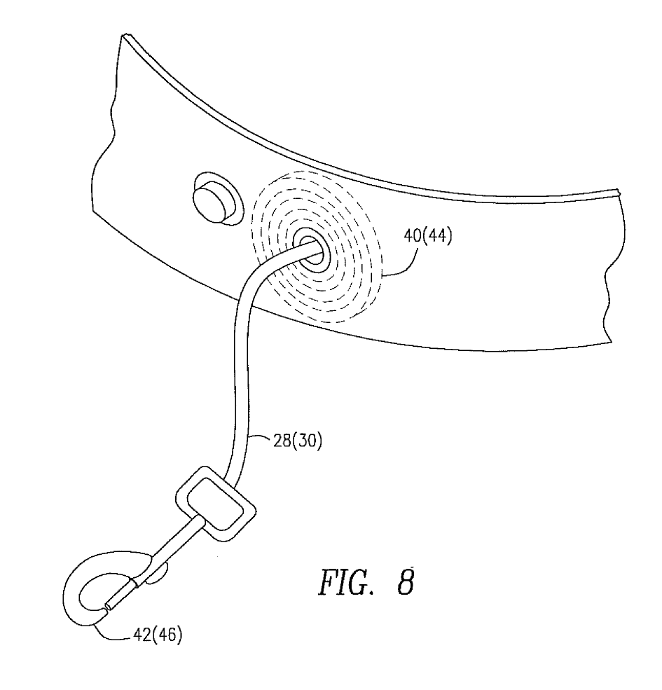

Specifically, by the hand imprint 36 in FIG. 3, the button 32 can be depressed to release the leash 28 in the direction shown by the arrow 100; while by similar hand imprint to the button 34, the leash 30 can be released as well. By the hand imprint 38 of FIG. 4, on then other hand, the ON-OFF illumination of the bulb or LED 24 can similarly be controlled to illuminate whenever desired. By the rolled-up retractable leash 40 in FIG. 8, the leash 28 can be extended as much as desired by depressing the button 32 in varying the freedom given to the dog clipped at the leash end 42. As will be appreciated, a similar such rolled-up retractable leash 44 is coupled with the leash 30, to allow an extension of that leash under the button 34 control in governing its own length, to which a second dog could be clipped at its own leash end 46. As will be appreciated, at the leash ends 42 and 44, either or both such ends could be coupled to the collar of the dog being walked, or could be coupled to individual others of such leashes for walking pairs or more of similarly leashed dogs under the control of one or both of the buttons 32, 34.

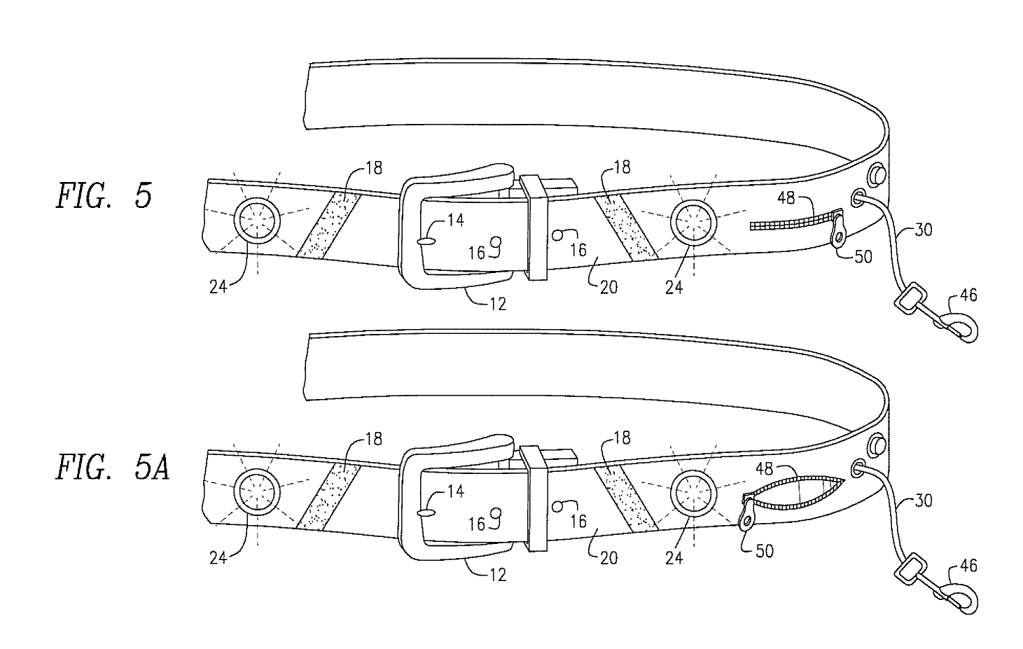

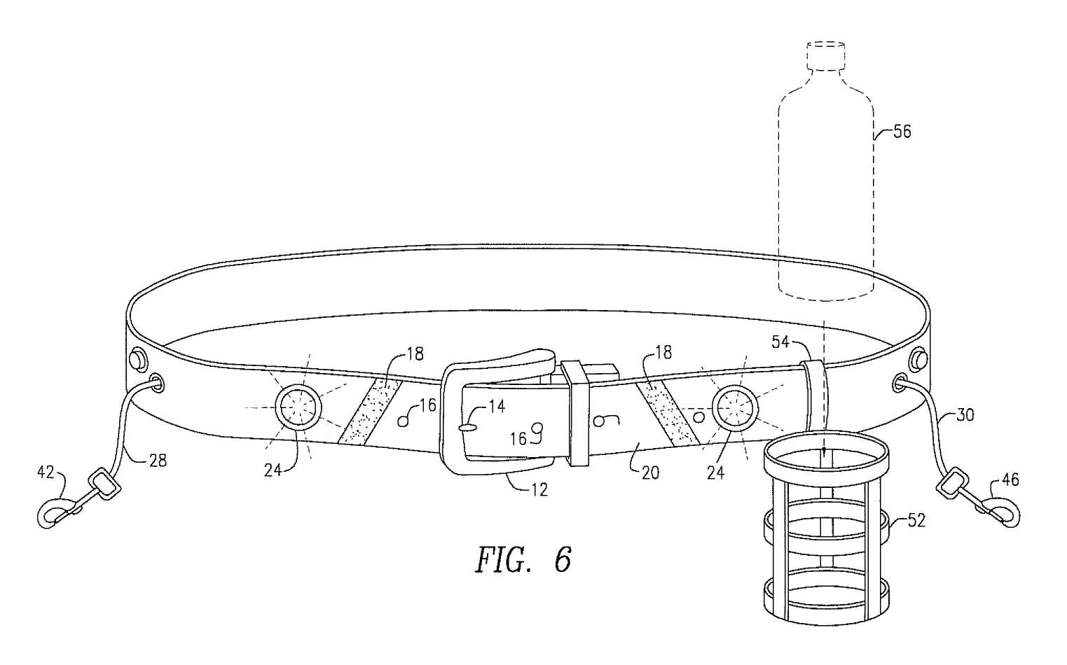

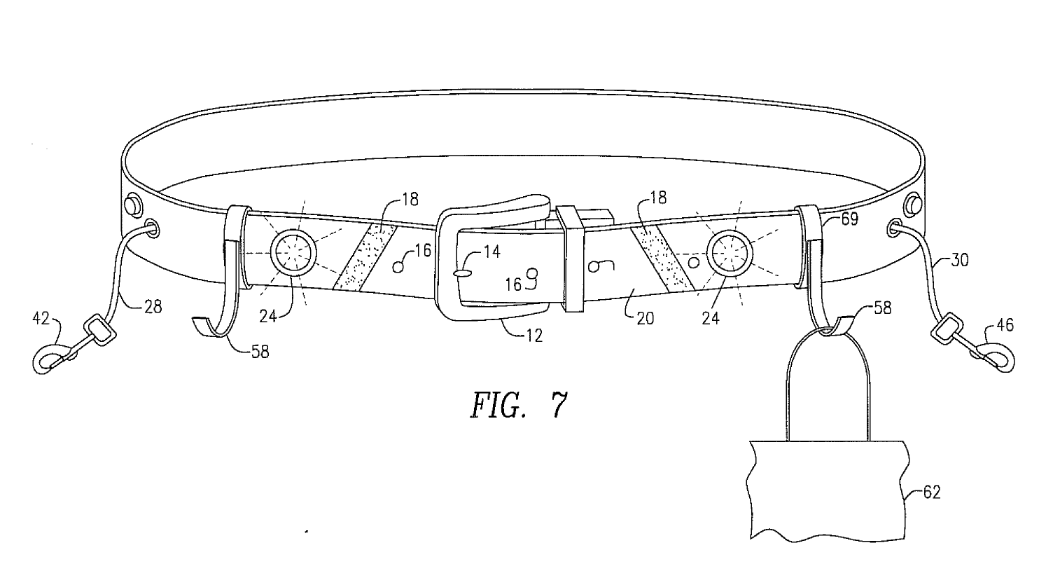

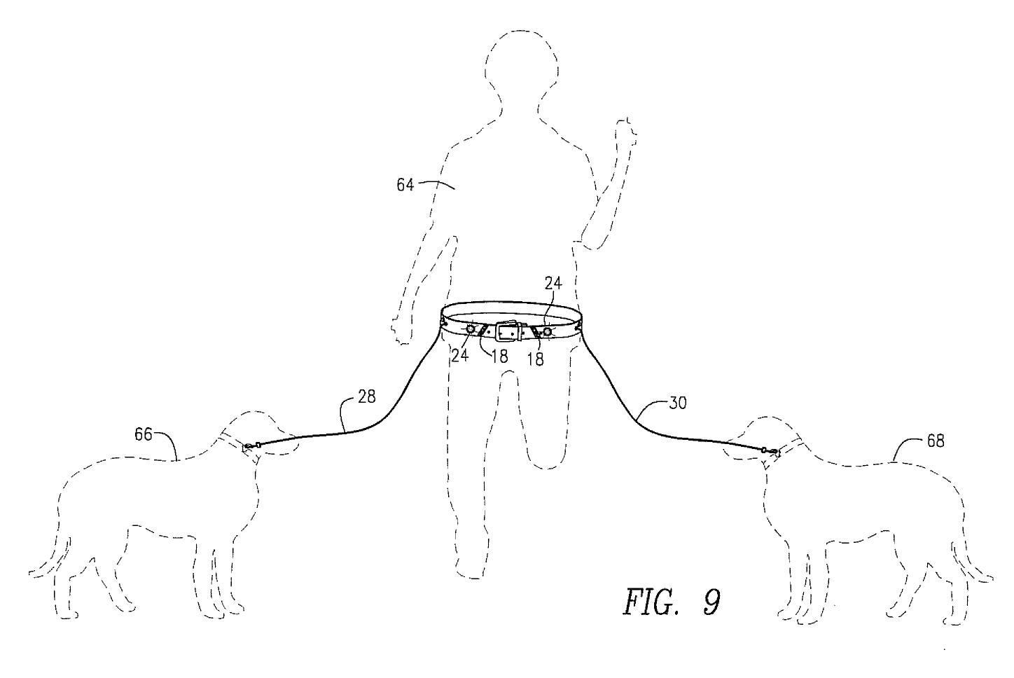

Other features of the invention are depicted in FIGS. 5, 5A, 6 and 7. In particular, FIG. 5A shows a pocket 48 closed by a zipper or like securement 50, while FIG. 5A shows the pocket 48 zippered open. FIG. 6 shows a holder 52 straddled about the belt 10 at 54 for the receipt of a water bottle 56 to be carried about in the walking of, or running with, the dog or dogs. FIG. 7 shows a hook 58 straddling the belt at 60 for the carrying of a grocery or shopping bag, or pocketbook 62. Such optional carryings are omitted from the more basic control configuration of FIG. 9, in which a handler 64 is wearing the belt about the waist, with the leashes 28, 30, extended to clip to the collars of the dogs illustrated at 66, 68. In the alternative arrangement of FIG. 9, the belt is shortened so as to be wound around an arm 70, the shortened belt being shown at 72. Although shown about only one arm of the handler 64, it will be appreciated that a second such shortened belt could be wrapped around the other arm as well, or about any part of the body where so desired.

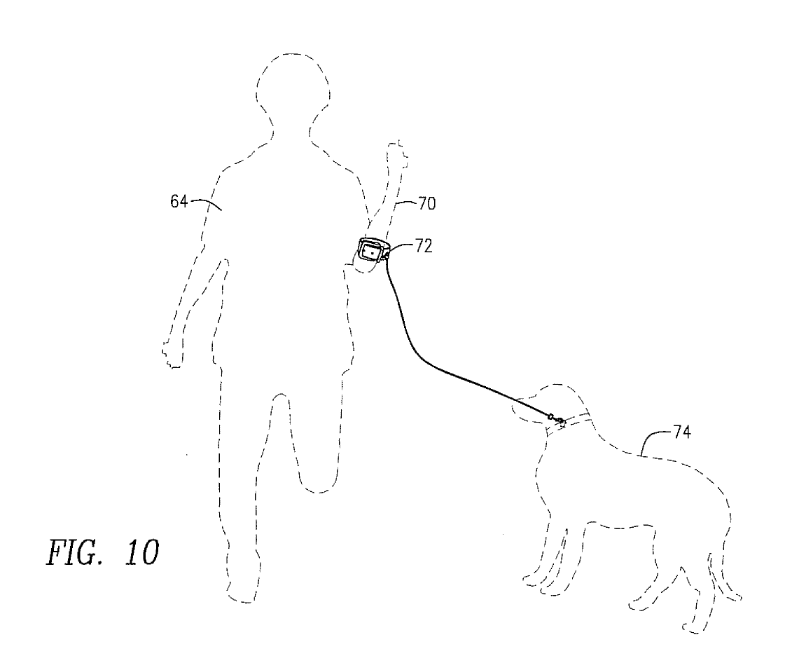

Although two dogs are being controlled in FIG. 9, and only one such dog 74 is controlled in FIG. 10, it will be understood that each of the belt-type configurations of the drawings could be employed to have available a control of walking one or two dogs in hands-free usage in allowing a handler to read a hand-held book or screen while walking, or speaking on a cellphone while walking or running with the dog without having to hold onto its leash. Walking, running, or biking in a hands-free manner at the same time with one or two pets thus becomes easily achievable, carrying, where desired, whatever might be desired as hanging from the belt. And, at the same time, the belt construction of the invention continues to provide sufficient illumination both during daytime and nighttime as would allow a safety factor to result in its visualization and detection.

While there have been described what are considered to be preferred embodiments of the present invention, it will be readily appreciated by those skilled in the art that modifications can be made without departing from the scope of the teachings herein—either just to obtain the psychological advantages of stress relief in having one or more dogs as a companion, or in providing professional dog-walking exercising and care for those performing such a function on a paid or just a neighborly basis. For at least such reason, therefore, resort should be had to the claims appended hereto for a true understanding of the invention.

I claim:

1. A belt sized for a wearer's waist or arm having front, back and opposing side sections, a retractable dog leash embedded in at least one side section manually extendable therefrom forwardly of said front section, and illumination means visible at one or both of said front and back sections of said belt.

2. The belt of claim 1 wherein said illumination means includes at least one of a manually energizible ON-OFF bulb and light-emitting diode.

3. The belt of claim 2 wherein said illumination means also includes at least one indicant reflective of shining light incident thereupon.

4. The belt of claim 3 including first and second retractable leashes, respectively, embedded in each of said opposing side sections of said belt.

5. The belt of claim 1 including means about said belt for supporting a grocery or shopping bag or pocketbook hanging downwardly from said front section of said belt.

6. The belt of claim 4 including means about said belt for supporting a grocery or shopping bag or pocketbook hanging downwardly from said front section of said belt.

7. The belt of claim 6, also including an openable-closable pocket in said front section of said belt.

8. The belt of claim 6, including ON-OFF control means for energizing said ON-OFF bulb and light-emitting diode to an illumination state thereof.

9. The belt of claim 8, additionally including manual control means for adjusting the length of said retractable dog leash extending forwardly of said front section of said belt.
